(19) United States
(12) Patent Application Publication
(10) Pub. No.: US 2016/0256945 A1
(43) Pub. Date: Sep. 8, 2016

(54) ELECTROCHEMICAL MACHINING METHOD, ELECTROCHEMICAL MACHINING APPARATUS AND ELECTROCHEMICAL MACHINING FLUID

(71) Applicant: MITSUBISHI ELECTRIC CORPORATION, Tokyo (JP)

(72) Inventors: Akihiro GOTO, Fukuroi-shi (JP); Nagao SAITO, Kasugai-shi (JP); Naotake MOHRI, Tokyo (JP); Yuichiro HAISHI, Owariasahi-shi (JP); Takashi YUZAWA, Tokyo (JP)

(73) Assignee: Mitsubishi Electric Corporation, Tokyo (JP)

(21) Appl. No.: 15/031,018

(22) PCT Filed: Nov. 5, 2013
(86) PCT No.: PCT/JP2013/006502

§ 371 Date: Apr. 21, 2016

(51) Int. Cl. B23H 3/08; C25F 3/02; B23H 3/10

(52) U.S. Cl. CPC B23H 3/08; B23H 3/10; C25F 3/02

(57) ABSTRACT

While switching polarity of an electrode, a voltage is applied between the electrode and a workpiece hard metal with the electrode used as a negative-electrode such that tungsten carbide (WC; component of the hard metal) is anodized to form a tungsten oxide (WO3), and a voltage is supplied therebetween with the electrode used as a positive-electrode such that cobalt (Co) that is a component of the workpiece is electrolytically-eluted and at the same time the WO3 generated by anodization is dissolved in the machining fluid, a saline solution (NaCl) or an aqueous solution of nitrate of soda (Na(No3)) is used as an machining fluid; a calcium salt is added beforehand to the machining fluid to react tungstate soda (Na2WO4) generated in the machining with the calcium salt whereby calcium tungstate (CaWO4) is produced; and a calcium compound is separated and recovered using a difference in specific gravity.

### FIELD

The present invention relates to electrochemical machining method and apparatus for a hard metal, and an electrochemical machining fluid thereof.

### BACKGROUND

Hard metals are materials made by sintering tungsten carbide (WC) with cobalt (Co) used as a binder, and an additional ingredient, such as titanium carbide (TiC) or tantalum carbide (TaC), is often used for the materials. Such a hard metal, which is a material having a high hardness and a high wear resistance, has often been machined into a desired shape by electric discharge machining in a conventional manner.

In the electric discharge machining, when achieving a maximum machining speed of 1 gr/min for rough machining, a roughness is approximately 50 μmRz and a ratio of wear of a copper-tungsten electrode is approximately 15%. Additionally, cracks may be generated. Even if a machining speed is reduced to approximately 0.2 gr/min so as to reduce the generation of cracks, a roughness of a finished surface is still 10 μmRz to 20 μmRz and a ratio of electrode wear is still approximately 15%.

When achieving a roughness of a finished surface of 4 μmRz, a maximum machining speed is 0.05 gr/min and a ratio of electrode wear is no less than 15%. Nonetheless, the electric discharge machining has been used to machine the hard metals into desired shapes at the time, and in spite of causing cracks in the electric discharge machining, the machining speed has been lowered to a large extent so as to reduce cracks, and any existing cracks have been removed by polishing operation and the resultant has been used a product.

Attempts are being made to machine hard metals into desired shapes based on a cutting operation recent years. Although results of research have been occasionally presented to suggest that hard metals can be machined by the cutting operation, wear in a cutting edge of a tool is large in amount and a machining speed is low especially in a rough machining step for roughly machining the hard metals, and so it is still difficult to reach economical realization of the cutting operation in machining the hard metals. In high-speed cutting or medium cutting, there is a problem in that margins of cutting conditions such as the amount of cutting of feeding cannot be increased, thereby taking much machining time. Time taken in the present machining speed is many times as long as that in the electric discharge machining. A grinding process and a grinding process using an electrodeposition tool have also been tried to do so as with the cutting process, but have the similar problem.

On the other hand, electrochemical machining had been studied several decades ago (See Non-Patent Literature 1, Patent Literature 1 and Patent Literature 2, for example). In the electrochemical machining, electrode wear is almost zero in amount, a machining speed in an area where a roughness of a finished surface is low (3 to 4 μmRz) is high, and no cracks in a machined surface are caused unlike in the electric discharge machining. The electrochemical machining has achieved a machining speed of 2 g/min, an extremely high speed, for realizing a surface roughness of 3 to 4 μmRz around 1967 (see FIGS. 4 and 5).

### CITATION LIST

### Patent Literature

Non-Patent Literature 1: Sachio Maeda, Nagao Saito and Yuichiro Haishi, “Mitsubishi Denki Giho” Vol. 41, No. 10 (1967) 1272-1279
Patent Literature 1: Japanese Patent Published Examined Application No. S41-1086
Patent Literature 2: Japanese Patent Published Examined Application No. S41-1087

The electrochemical machining essentially has superb machining characteristics as described above, but it has not been put in practical use due to some significant weak points. The weak points include a fact that property change of the electrochemical machining fluid is caused and a machining process cannot be continued, a fact that chlorine gas may be generated that poses safety problems, a fact that any treatment process for chemically-changed sludge generated in the machining has not been established and other facts.

### SUMMARY

### Technical Problem

As described above, it can be said that despite the results of research that have been obtained, electrochemical machining techniques at that time have been immature for industrial products. Some problems thereof will be described in detail below after additional description of the electrochemical machining techniques used for hard metals at that time.

Now description is given below as to what electrochemical reaction is subjected to machining of a hard metal. A hard metal contains WC and Co as principal components, and sometime contains TiC or TaC. Described is for what electrochemical reaction causes each component to be eluted and removed. It is assumed here that an aqueous solution of NaCl or an aqueous solution of NaCl+NaOH is used for an electrolytic solution.

A reaction of tungsten carbide (WC), which is a principal component of a hard metal, is observed at first. When a hard metal is used to be a positive electrode, its surface is anodized to form a layer of a vivid indigo color. This is WO3, which is produced from the oxidation of WC. When the hard metal is then used to be a negative electrode to allow WO3 to come in contact with Na ions, a gas is vigorously generated from the surface, that is WO3, to turn the color of the surface into a bare color of the hard metal. This reaction is expressed in chemical equations as below.

(Anode) WC+9/2[O]→WO3+1/2CO+1/2CO2 Expression (1)

(Cathode) WO3+2NaOH→Na2WO4+H2O Expression (2)

The machining can be performed with an electrochemical machining fluid of NaNO3 in place of NaCl.

The elution of cobalt (Co) is described next. When the hard metal is used to be a positive electrode, Co, which is an ordinary metal, reacts as below to be eluted.

Co+2Cl−−2e−→CoCl2 Expression (3)

CoCl2, which is soluble in water, reacts with water (H2O) in the electrolytic solution after the elapse of several hours, and turns to Co(OH)2 and release Cl, which reacts with Na ions to produce NaCl.

The elution of titanium carbide (TiC) is described next. It is considered that TiC is eluted by the chemical reactions shown below.

(Anode) TiC+7/2[O]→TiO2+1/2Co+1/2Co2 Expression (4)

(Cathode) TiO2+2H2O→Ti(OH)2 Expression (5)

This series of chemical equations are equations assumed after studying on the basis of experiments, by analysis and other studies of products of reactions. The chemical reactions of TiO2 with Ti(OH)2 has a process of TiCl2.

It is contemplated that tantalum carbide (TaC) undergoes a reaction similar to that of TiC.

It is assumed that an aqueous solution of NaCl is used as the base of the electrochemical machining fluid with NaOH added, and when sodium nitrate (NaNO3) is used, NO3 is used in place of Cl.

The example described above adopts a manner in which the polarity of the electrode is alternately switched between positive and negative, but this manner is not a limitation. In the example, when the electrode is used to be a negative electrode, Co, which is metal, is eluted and, at the same time, tungsten carbide (WC) and the like are anodized. Dissolving a tungsten oxide (WO3) and the like that have been subjected to the anodization does not necessarily require the electrode to be used to be a positive electrode, and WO3 is only required to be exposed to a component for dissolving WO3 (for example, Na+ions).

The reactions of the electrochemical machining on a hard metal that has previously been studied has been described. The reactions have the following two main problems. Firstly, a mixture of a saline solution (NaCl) and caustic soda (NaOH) is used as an electrochemical machining fluid for the hard metal, and then a specific component (Na) of the electrochemical machining fluid is immobilized in the form of sodium tungstate (Na2WO4) in a chemical reaction during the machining operation. Therefore the amount of (Na) necessary for the machining decreases as the machining proceeds, the machining capacity is degraded as the machining continues, and then the machining is disabled eventually. Consequently, it is necessary to take measures to maintain an appropriate value of the Na component in the machining fluid for continuous machining, and replenishment and replacement work are required to do so. Secondly, it is a problem about a recovery of resources. It is conceivable that disposing of a waste fluid may become an environmental problem. It may be a certain environmental problem because a heavy metal such as tungsten (W) is contained in the machining fluid. This also means that tungsten, which is an expensive resource, is discarded adversely.

The present invention is to solve these problems.

That is, a first object is to solve an important problem of how sodium tungstate (Na2WO4) generated during machining be separated and removed. A second object is to solve an important problem of how an Na ion component, the amount of which is decreased, be replenished with ease.

Furthermore, the electrochemical machining performed on a hard metal with the polarity of an electrode switched between positive and negative has other problems of generation of chlorine gas and wear of the electrode, and then a third object is to solve these problems.

### Solution to Problem

An electrochemical machining method of the first invention is characterized in that an electrochemical machining method, in which electrochemical machining is performed by applying a voltage to pass a current between an electrode and a hard metal that is a workpiece with the electrode used as a negative electrode such that tungsten carbide (WC) that is a component of the hard metal workpiece is anodized to form a tungsten oxide (WO3) and, at the same time, cobalt (Co) is electrolytically eluted, and by chemically dissolving the tungsten oxide (WO3) generated by the anodization, the method comprising: using a saline solution (aqueous solution of NaCl) or an aqueous solution of nitrate of soda (Na(No3)) as an electrochemical machining fluid; adding in advance a calcium salt (Ca(OH)2, CaCl2, Ca(NO3)2, etc.) to the electrochemical machining fluid to allow tungstate soda (Na2WO4) generated in the electrochemical machining and the calcium salt (Ca(OH)2, CaCl2, Ca(NO3)2, etc.) to undergo a reaction whereby calcium tungstate (CaWO4) is produced; and separating and recovering a calcium compound by using a difference in specific gravity, for example, by settling or centrifugal separation.

### Advantageous Effects of Invention

An invention of the present application can prevent a machining fluid from undergoing a change in property due to continued machining operation and thereby disabling the machining, preclude generation of a poisonous gas, and recycle sludge generated during the machining as a useful resource.

### BRIEF DESCRIPTION OF DRAWINGS

FIG. 1 is a schematic diagram illustrating the entirety of an electrochemical machining apparatus including an electrodeposition device for a metal component in electrochemical machining of a hard metal.

FIG. 2 includes a top view and a sectional view of the electrodeposition device for the metal component in the electrochemical machining of a hard metal.

FIG. 3 is a schematic diagram illustrating a device that recovers chlorine gas.

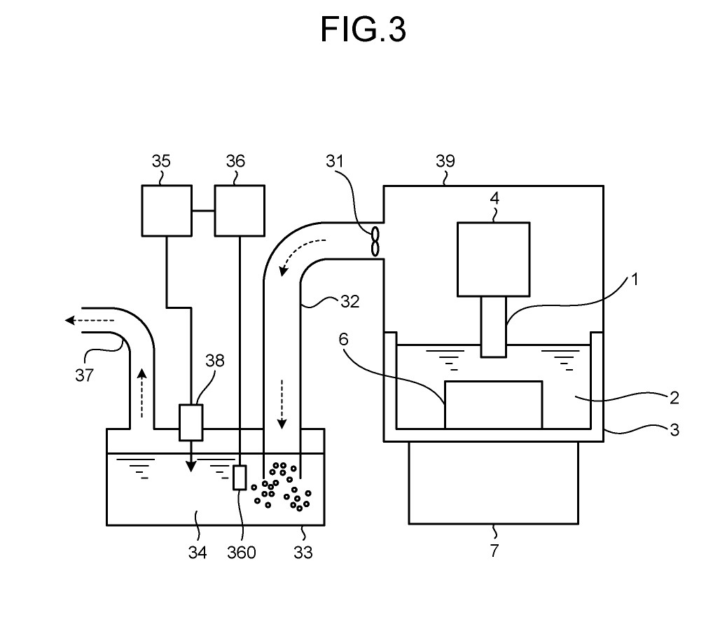

FIG. 4 is a diagram for describing machining examples of the conventional electrochemical machining.

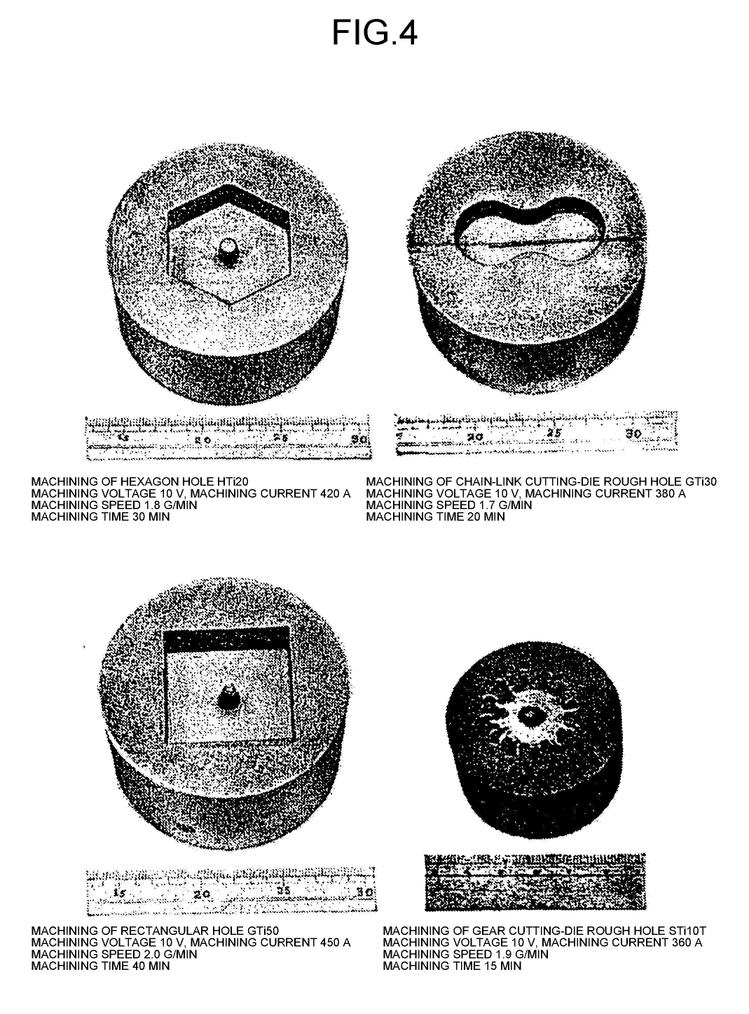

FIG. 5 is a diagram for describing machining examples of the conventional electrochemical machining.

### DESCRIPTION OF EMBODIMENTS

### Embodiment 1

As described above, problems with the conventional electrochemical machining of a hard metal include an impossibility of performing machining due to a deficiency of sodium ions during the machining and an inability to recover tungsten, which is a valuable resource. In the present invention, attention is focused on the following point. Namely, an electrochemical machining method in which the machining is performed by applying a voltage to pass a current between an electrode and a hard metal, which is a workpiece, with the electrode being used as a negative electrode such that tungsten carbide (WC), which is a component of the hard metal workpiece, is anodized to form a tungsten oxide (WO3) and, at the same time, cobalt (Co) is electrochemically eluted, and by chemically dissolving the tungsten oxide (WO3) generated by the anodization, a tungstate ion (WO4 2−) reacts with a calcium (Ca) ion.

Specifically, although sodium tungstate (Na2WO4) that is a product of the electrochemical machining of the hard metal is water soluble and can hardly be separated from other ions and the like, it has been found that, by using a saline solution (an aqueous solution of NaCl) or an aqueous solution of nitrate of soda (Na(No3)) as an electrochemical machining fluid and adding in advance a calcium salt (one that contains a calcium ion (Ca 2+), such as calcium hydroxide Ca(OH)2, calcium chloride CaCl2, and calcium nitrate Ca(NO3)2, for example) to the electrochemical machining fluid, and the calcium salt undergoes a reaction in which Na is replaced by Ca to yield CaWO4 (calcium tungstate). That sodium tungstate, which is a Na salt of the tungsten oxide (WO3), is water soluble, but the inventors have paid attention to the fact that the other salts (for example, calcium tungstate (CaWO4), which is an alkaline-earth metal salt) are insoluble. The chemical reactions proceed as below.

Na2WO4+Ca(OH)2→CaWO4+2NaOH Expression (6)

Na2WO4+CaCl2→CaWO4+2NaCl Expression (7)

Na2WO4+Ca(NO3)2→CaWO4+2Na(NO3) Expression (8)

In the case where an electrochemical machining fluid containing an aqueous solution of NaCl as the principal component is used, it is desirable that CaCl2 be added in addition to Ca(OH)2 to increase the amount of Ca ions in the electrochemical machining fluid and that, in order to inhibit the electrochemical machining fluid from becoming acidic due to increased Cl ions in the electrolytic solution, sodium hydroxide (NaOH) be added to allow the electrochemical machining fluid to be alkaline. In the case where an electrochemical machining fluid containing an aqueous solution of Na(NO3) as the principal component is used, it is desirable that Ca(NO3)2 be added in advance and that, in order to inhibit the electrochemical machining fluid from becoming acidic due to excess NO3 ions increased because of the addition of Ca(NO3)2, sodium hydroxide (NaOH) be added similarly to allow the electrochemical machining fluid to be alkaline.

Calcium tungstate, which is insoluble and, moreover, has a specific gravity of approximately six, settles out readily and thus is recovered easily. It can be separated readily by a centrifugal separation scheme or the like. CaWO4 (calcium tungstate) is a material used immediately before tungsten is refined. Moreover, it is particularly of high purity because it is obtained via the electrochemical reactions from a product of the electrochemical machining of a hard metal. This means that tungsten, which is a valuable resource, can be recovered nearly completely.

As described above, CaWO4 (calcium tungstate) can be separated readily, but when it stays between the electrodes during the electrochemical machining process, the machining may be hindered. For this reason, when there is a demand for a special attention to the machining performance, it is better that CaWO4 (calcium tungstate) be settled out and recovered in a second machining tank provided separately from a machining tank in which the electrochemical machining is performed, and that a circulating electrochemical machining fluid is guided into the second machining tank, in which a Ca ion is added to allow CaWO4 (calcium tungstate) to be settled out and recovered.

A metal component, such as cobalt, is eluted during the electrochemical machining, and subsequently changes into a chloride and then, as time elapses, into a hydroxide to separate chlorine ions and thereby allow the electrolytic solution to turn back into NaCl, so that in theory, the machining fluid can be continuously used as the electrochemical machining fluid only with replenishment of water. It is understood from Expressions (6), (7) and (8) that the Na ions used for the generation of Na2WO4 turn back into the original state of the machining fluid. Note that Ca(OH)2 in Expression (6) is slaked lime and is not readily dissolved in water. Merely 0.18 g or less of Ca(OH)2 is melted in 100 g of water. To compensate for this, using CaCl2 of Expression (7) instead results in dissolution of as much as 74.5 g in 100 g of water and thereby enables the chemical reaction in Expression (7) to be stronger. This, however, means that the amount of Cl ions is increased in the machining fluid in its entirety, and so in order to dissolve the tungsten oxide (WO3), it has been revealed that an excessive amount of NaOH needs to be added to replenish Na ions.

It has been found that sodium hydroxide NaOH should be added to keep the electrochemical machining fluid alkaline while the pH value of the electrochemical machining fluid is measured. This is because it is desirable in state that an excessive amount of Na+ be present in the electrochemical machining fluid, that is, that the electrochemical machining fluid be alkaline.

### Embodiment 2

In Embodiment 1, the recovery of tungsten has been described, but Embodiment 2 is a method as to an efficient method of recovering a metal component and the like different from tungsten. A configuration similar to those in other embodiments may be used, unless otherwise noted.

Co, Ti, Ta and the like first change into chlorides in the reactions of the electrochemical machining to yield CoCl2, TiC2 and TaCl2, and then, as time elapses, form hydroxides to release Cl ions and reproduce NaCl, thereby allowing the electrolytic solution to revert back to its original state. These metals can be recovered in the state of the hydroxides, but this means that they are recovered as sludge, which has a large volume and involves a time-consuming post process. Since it is preferable that Co, Ti and Ta be recovered in the state of metal with high purities in order to regenerate them as recycled resources, the inventors focused attention on electrodeposition. However, the reactions at the timing of the hydroxides have progressed too far to perform the electrodeposition efficiently and thus lead to significant degradation in efficiency of the recovery.

It is desirable that the timing at which the electrodeposition is performed be immediately after the electrochemical machining is performed. For example, when the polarity of the hard metal that is a workpiece is positive after cobalt (Co), which is a metal component of a hard metal, and titanium carbide (TiC) added as a component of the hard metal yield TiO2 by a chemical reaction, and this TiO2 is dissolved in an electrochemical machining fluid, a voltage is desirably applied to the electrochemical machining fluid for the electrodeposition and recovery. The metals are preferably ionized to perform the electrodeposition, and the electrodeposition should be performed during a period of the state of chlorides. The electrodeposition has been evaluated with a period of time after the electrochemical machining varied, and then it has been revealed that the period of time is desirably five hours or less and that it needs to be performed within a period of time of approximately 10 hours or less at maximum. The period of time is equal to or longer than 10 hours, yield is decreased. By performing the electrodeposition immediately after a reaction of the electrochemical machining, substances deposited in the form of metals are produced, thereby resulting in a useful way because, even though some of the hydroxides remains, the amount of the hydroxides generated can be reduced.

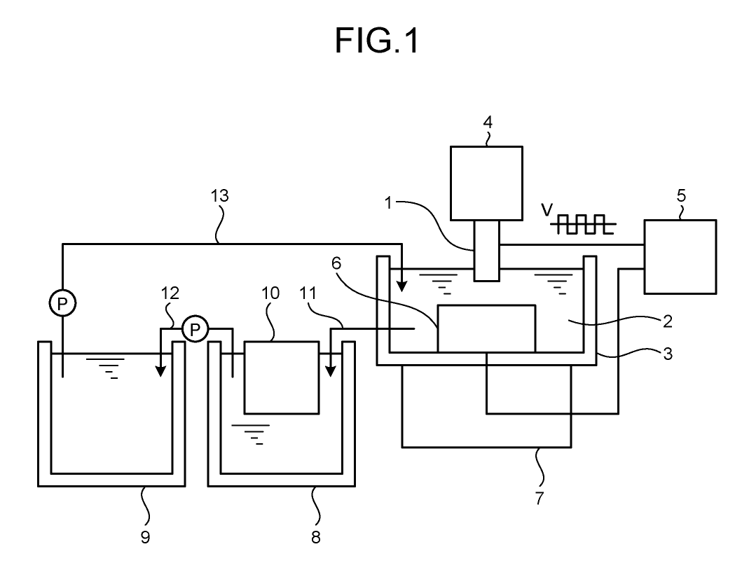

In FIG. 1, there is shown a schematic diagram illustrating the entirety of an electrochemical machining apparatus including an electrodeposition device. With reference to FIG. 1, the electrochemical machining apparatus according to the present invention is configured to include a machining head 4, an electrode 1 attached to the machining head 4, a driver (not illustrated) that supports the machining head 1 and moves the machining head 4 in three axes (X, Y and Z axes), a machining tank 8 filled with an electrochemical machining fluid 2 (hereinafter also referred to simply as machining fluid), in which a workpiece 6 is dipped, a bed 7 that supports the machining tank 8, a power source 7 that supplies an AC voltage to the electrode 2 and the workpiece 6, and a controller (not illustrated) that controls these components.

The machining fluid 2 flows from the machining tank 4 through a pipe 11 to a recovery tank 8 at all times, and in the recovery tank 8, Co, Ti and Ta are recovered by an electrodeposition device 10. The machining fluid 2, from which Co and the like have been recovered, passes through a pipe 12 into a tank 9 for temporary storage. The machining fluid 2 stored in the tank 9 then passes through a pipe 13 to be returned back to the machining tank 3. As described above, the machining fluid 2 is circulated from the machining tank 4 to the recovery tank 8, and then to the tank 9 in this order.

The electrodeposition device 10 will now be described. It is important that the electrolytic deposition device 10 be adapted to perform electrodeposition with a minimum possible power consumption and have facilities to allow a deposited substance to be recovered easily. For these reasons, the device 10 has a configuration as below.
(1) A large drum-type electrode is used to achieve a large area for the electrodeposition and continuous use, and while the drum with electrodeposited metals attached is rotated, the metals are scraped off the drum.
(2) To achieve a smaller power to perform the electrodeposition than that required for the machining, the area of the electrode for the electrodeposition is enlarged and the distance between the electrodeposition electrodes is decreased.

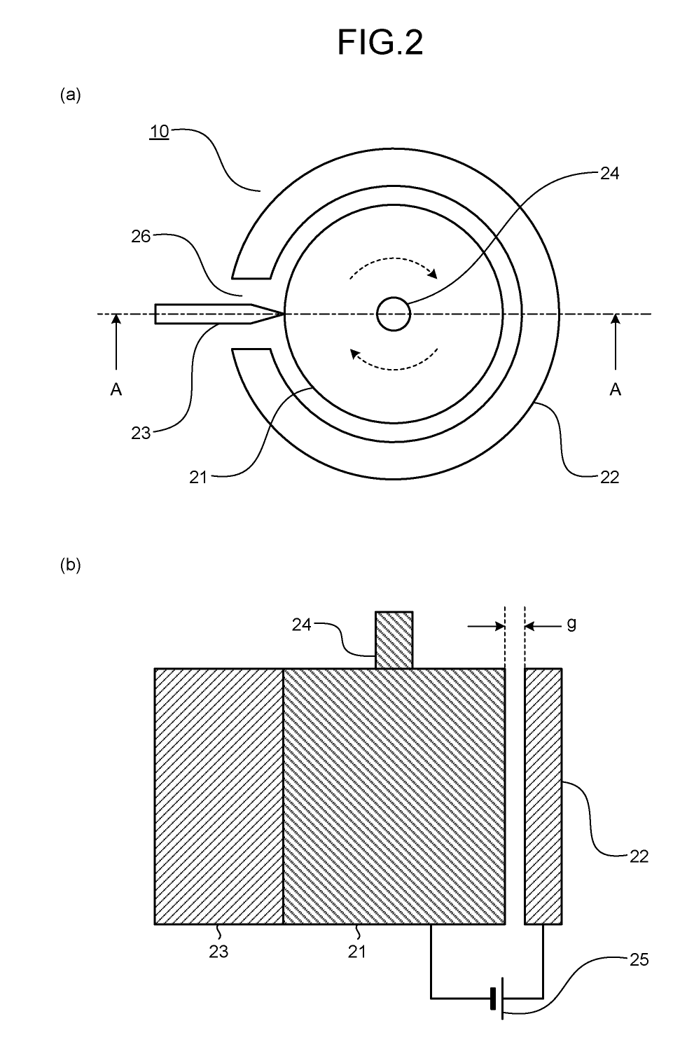

The configuration and operation of the electrodeposition device 10 are now described in detail. FIG. 2 includes a top view (FIG. 2 (a)) of the electrodeposition device 10 and a sectional view (FIG. 2 (b)) along A-A in the top view. As illustrated in FIG. 2, the electrodeposition device 10 includes a first electrode 21 having a circular cylindrical shape and a second electrode 22 having a hollow tubular shape, which is disposed in such a manner that it surrounds the first electrode 21 with a predetermined gap (g) therebetween. The electrodeposition device 10 also includes a power source 25 that supplies a voltage using the first electrode 21 as a negative electrode and the second electrode 22 as a positive electrode. The first electrode 21 includes a rotation shaft 24 along the central axis of its cylindrical shape and is rotated about the rotation shaft 24 by an undepicted driver. The second electrode 22 has, in a partial area thereof, a cutout 26 along the direction of the rotation shaft 24 and in the cutout 26 a planar scraper 25 is disposed and has butt contact with a side of the first electrode 21 along the direction of the rotation shaft 24.

The machining fluid 2 flowing in the recovery tank 8 is subjected to electrodeposition by the first electrode 21, which is the negative electrode, and the second electrode 22, which is the positive electrode, of the electrodeposition device 10. Co, Ti and Ta are deposited on a surface of the first electrode 21, which is the negative electrode. As the first electrode is rotated about the rotation shaft 24, the Co and the like deposited on the surface of the first electrode 21 are scraped by the scraper 25 off and settle out on the bottom of the recovery tank 8. By recovering the settling substances, the metals such as Co can be recovered.

The relationship among an area S of the side of the first electrode 21, an inter-electrode gap g, an electrolytic current i, power E, and a specific resistance ρ in the electrodeposition device in the machining fluid in the recovery tank 8 is described, where
i: an electrolytic current in ampere (A)
E: an inter-electrode voltage in volt (V)
ρ: a specific resistance in Ωcm
S: the area of the electrode in cm2
g: an inter-electrode distance in cm, and
R: the total resistance of the electrolytic solution between the electrodes in (Ω).
Since i=E/R and R=ρg/S, R decreases when g is made smaller and S is made greater.

The first electrode of the electrodeposition device in FIG. 2 is a positive electrode, and so needs to be insoluble. A material used for plating, such as platinized titanium material and a platinized copper material, is used for the first electrode.

### Embodiment 3

In Embodiment 1, a method of recovering tungsten (W) in the electrochemical machining of a hard metal has been described. The method is a method in which the machining is performed by anodizing tungsten carbide (WC), with an electrode used as a negative electrode, to form a tungsten oxide (WO3) and, at the same time, eluting cobalt (Co) by electrolysis, and by chemically dissolving the tungsten oxide (WO3) generated by the anodization, and the method is not necessarily limited to a case in which a condition of the electrode being used as a positive electrode and another condition of the electrode being used as a negative electrode are repeated alternatingly. To take the efficiency of the machining into consideration, however, it is desirable that the electrode be used as a positive electrode to attract Na+ toward the workpiece so as to actively dissolve the tungsten oxide (WO3). Embodiment 3 relates to a method in which the machining is performed while the polarity of the electrode is switched between positive and negative. A configuration similar to those in other embodiments may be used, unless otherwise noted.

The method in which the electrochemical machining is performed on a hard metal while the polarity of an electrode is switched between positive and negative has another disadvantage of wear of the electrode. When an ordinary metal, such as brass, is used as the electrode, in particular, the electrode wears away significantly to an extent of two to three times in weight and approximately four times in length wear as much as WC—Co. This is because, when the electrode is used as a positive electrode, the reaction of Cl causes the wear of the electrode. Materials that cause no chemical reaction with Cl include graphite, which involves volume wear of 3 to 5%. The reason even graphite involves some wear is because the electrode serving as the anode causes it to be anodized. It has been reported that the wear of a graphite electrode is decreased to zero by adding cobalt chloride (CoCl2), on the basis of the knowledge obtained empirically that an old machining fluid having been used considerably for the machining of a hard metal shows a decrease in wear of the electrode. It has been reported that, when an aqueous solution of NaCl is used as an electrochemical machining fluid, 0.5% addition of CoCl2 can result in the wear of the electrode being decreased to zero. The reason is as below.

When an electrolytic solution is just a saline solution alone, in a half cycle in which the electrode is positive, nascent oxygen is generated at the anode at the same time as Cl gas and hydrogen gas are generated from the anode and the cathode, respectively, by electrolysis of the saline solution. The nascent oxygen reacts with carbon of the electrode to disperse carbon dioxide gas and thereby causes the electrode to wear away.

C+2[O]→CO2 Expression (10)

On the other hand, the addition of cobalt (Co) to the electrolytic solution causes cobalt ions dissociated in the solution to deposit on the surface of the electrode in the form of metallic cobalt while the electrode serves as the cathode.

Co2++2e→Co Expression (11)

Then, while the electrode serves as the anode, the deposited metallic cobalt reacts again with chloride ions electrochemically to be eluted.

Co+2Cl−−2e−→CoCl2 Expression (12)

Conceivably, no wear of the graphite electrode is caused because only the deposition and the elution of the metallic cobalt occur on the surface of the electrode as described above, and the quantity of electricity for generating the nascent oxygen is all spent in the reactions of Expression (11) and Expression (12).

A result of testing with various materials indicates that adding cobalt chloride (CoCl2), nickel chloride (NiCl2), ferrous chloride (FeCl2), or ferric chloride (FeCl3) to the electrochemical machining fluid can decrease the wear of a graphite electrode. It also suggests that it is more effective when the amount added is in a range of 0.1wt % or more and the temperature of the fluid is 30° C. or more for stronger reactions.

It further indicates that, when nitrate of soda (Na(NO3)) or potassium nitrate (K(NO3)) is used for the electrochemical machining fluid, adding iron nitrate (II) (Fe(NO3)2).6H2O), iron nitrate (III) (Fe(NO3)3.9H(H2O), nitrates of cobalt (2Co(NO2)3.6KNO2.3H2O), or nickel nitrate (Ni(NO3)2.6H2O) to the electrochemical machining fluid produces a similar effect. It suggests that it is more effective when the amount added in this case is also in a range of 0.1wt % or more and the temperature of the fluid is 30° C. or more for stronger reaction.

### Embodiment 4

In a method in which the electrochemical machining is performed on a hard metal while the polarity of an electrode is switched between positive and negative, a graphite electrode may be used to suppress the wear of the electrode. In this case, since the graphite electrode does not react with Cl, Cl gas is generated in a cycle in which the electrode serves as a positive electrode. Embodiment 4 relates to a method of processing the generated Cl gas or the like in the machining method according to Embodiment 1 or 2 in which the machining is performed while the polarity of the electrode is switched between positive and negative. A configuration similar to those in other embodiments may be used, unless otherwise noted.

A chlorine gas treatment device has been earlier studied in which Cl gas generated in a machining tank is allowed to pass through a treatment tank filled with an aqueous solution of caustic soda (NaOH) such that the Cl gas is absorbed. The use of a solution prepared by adding several tens % of NaOH to an aqueous solution of NaCl (or an aqueous solution of NaNO3) allows the generated Cl gas (or NO3 gas) to chemically react with NaOH to be absorbed. It has been found, however, that it eventually fails to absorb the chlorine gas as it is used continuously. This is because absorbing chlorine leads to a decrease in NaOH and thereby a failure to absorb chlorine further. Then, it has been just revealed that a decrease in NaOH can be detected by measuring the hydrogen ion concentration in the machining fluid. The concentration of NaOH in the electrochemical machining fluid can be controlled using the hydrogen ion concentration, and then a predetermined hydrogen ion concentration is reached to make the machining fluid alkaline, so that the chlorine gas can be absorbed continuously. An alarm can be automatically generated, the machining apparatus can be interrupted, or NaOH can be replenished automatically.

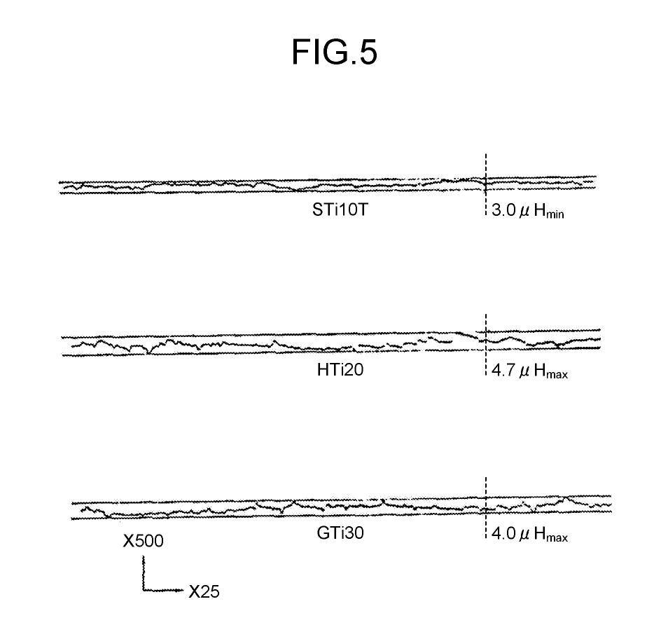

FIG. 5 is a diagram illustrating the configuration of a device that treats chlorine gas generated during the electrochemical machining in a case in which NaOH is replenished automatically. The electrochemical machining device itself illustrated in this figure is identical with that illustrated in FIG. 1. As illustrated in FIG. 5, a cover 39 is provided such that it covers the entire surface of the machining fluid 2 in the machining tank 3 so as to recover all the chlorine gas generated during the electric field machining. In FIG. 5, the machining head 4 and the electrode 1 are also covered by the cover 39, but there is no need to cover the machining head 4 and the like as long as the entire surface of the machining fluid 2 can be covered. The cover 39 is provided with a pipe 32, and a fan 31 is placed in the pipe 32 to forcibly exhaust gas from the space covered by the cover 39 through the pipe 32. The pipe 32 has an end inserted in an aqueous solution of the caustic soda (NaOH) stored in a treatment tank 33. That is, the gas flown through the pipe 32 is discharged into the aqueous solution of NaOH to pass through the aqueous solution of NaOH. The treatment tank 33 is provided with a pipe 37 separately from the pipe 33 for exhaust air, and the gas passing through the aqueous solution of NaOH is exhausted to the outside therethrough.

A sensor 39, which measures the hydrogen ion concentration, is provided in the aqueous solution of NaOH in the treatment tank 33, and the sensor 39 is connected to a hydrogen ion concentration meter 36 to measure the hydrogen ion concentration. Data of the measured hydrogen ion concentration are transmitted to a control device 35, and when the control device 35 determines from a change in the data that the concentration of NaOH is decreased below a predetermined value, the control device 35 instructs a NaOH supply unit 38, which is provided to the treatment tank 33, to supply NaOH. On receipt of the instruction, the NaOH supply unit 38 supplies NaOH to the aqueous solution of NaOH in the treatment tank 33.

Note that, instead of providing the NaOH supply unit 38, the control device 35 may be configured to generate an alert or stop the machining apparatus when the concentration of NaOH decreases below the predetermined value as described above.

### Embodiment 5

As described above in the embodiments, the electrochemical machining is performed on a hard metal using an electrochemical machining fluid with sodium hydroxide (NaOH) or potassium hydroxide (KOH) added to the machining fluid. These chemicals are deleterious substances and thus require careful handling. It is preferable that the use of a deleterious substance be avoided for electrochemical machining. To this end, it has been found that a safe material can be used except part(s) for which the deleterious substrate is needed, as mentioned below. That is, in order to supply sodium hydroxide (NaOH) to an electrochemical machining fluid, an electrochemical machining fluid containing sodium carbonate (Na2CO3) or sodium hydrogen carbonate (NaHCO3) is used, and when the electrochemical machining is executed, the machining fluid is heated to a temperature of 63° C. or higher such that CO2 can be released to generate NaOH, but when the machining is not executed, CO2 is caused to pass through the electrochemical machining fluid such that sodium carbonate (Na2CO3) or sodium hydrogen carbonate (NaHCO3) can be restored.

### INDUSTRIAL APPLICABILITY

An electrochemical machining method according to the invention is suitable for electrochemical machining for a hard metal containing WC or Co as its principal component.

1. An electrochemical machining method, in which electrochemical machining is performed by applying a voltage to pass a current between an electrode and a hard metal that is a workpiece with the electrode used as a negative electrode such that tungsten carbide (WC) that is a component of the hard metal workpiece is anodized to form a tungsten oxide (WO3) and, at the same time, cobalt (Co) is electrolytically eluted, and by chemically dissolving the tungsten oxide (WO3) generated by the anodization, the method comprising:
using a saline solution (aqueous solution of NaCl) or an aqueous solution of nitrate of soda (Na(No3)) as an electrochemical machining fluid;
adding in advance a calcium salt to the electrochemical machining fluid to allow tungstate soda (Na2WO4) generated in the electrochemical machining and the calcium salt to undergo a reaction whereby calcium tungstate (CaWO4) is produced; and
separating and recovering a calcium compound by using a difference in specific gravity.

2. The electrochemical machining method according to claim 1, wherein, when the electrochemical machining fluid containing an aqueous solution of NaCl as a principal component is used, CaCl2 is added in addition to Ca(OH)2 to increase the amount of Ca ions in the electrochemical machining fluid, and, in order to inhibit the electrochemical machining fluid from becoming acidic due to increased Cl ions in an electrolytic solution, sodium hydroxide (NaOH) is added to allow the electrochemical machining fluid to be alkaline.

3. The electrochemical machining method according to claim 1, wherein, when the electrochemical machining fluid containing an aqueous solution of Na(NO3) as a principal component is used, Ca(NO3)2 is added in advance, and, in order to inhibit the electrochemical machining fluid from becoming acidic due to excess NO3 ions increased because of the addition of Ca(NO3)2, sodium hydroxide (NaOH) is added to allow the electrochemical machining fluid to be alkaline.

4. The electrochemical machining method according to claim 1, wherein calcium salt is added to the electrochemical machining fluid in a second tank provided separately from a machining tank in which the electrochemical machining is performed.

5. An electrochemical machining method, in which electrochemical machining is performed by applying a voltage to pass a current between an electrode and a hard metal that is a workpiece with the electrode used as a negative electrode such that tungsten carbide (WC) that is a component of the hard metal workpiece is anodized to form a tungsten oxide (WO3) and, at the same time, cobalt (Co) is electrolytically eluted, and by chemically dissolving the tungsten oxide (WO3) generated by the anodization, the method comprising:
using a saline solution (aqueous solution of NaCl) or an aqueous solution of nitrate of soda (Na(No3)) as an electrochemical machining fluid; and
adding sodium hydroxide (NaOH) to the electrochemical machining fluid while measuring a pH of the electrochemical machining fluid so as to make the electrochemical machining fluid to be alkaline, in order to facilitate dissolving in the electrochemical machining fluid the tungsten oxide (WO3) produced by anodizing the tungsten carbide (WC).

6. An electrochemical machining method, in which electrochemical machining is performed by applying a voltage to pass a current between an electrode and a hard metal that is a workpiece with the electrode used as a negative electrode such that tungsten carbide (WC) that is a component of the hard metal workpiece is anodized to form a tungsten oxide (WO3) and, at the same time, cobalt (Co) is electrolytically eluted, and by chemically dissolving the tungsten oxide (WO3) generated by the anodization, the method comprising:
dissolving, in an electrochemical machining fluid, cobalt (Co), which is a metal component of the hard metal, and TiO2, which is produced in a chemical reaction of titanium carbide (TiC) added as a component of the hard metal, when a polarity of the hard metal that is a workpiece is positive; and
applying a voltage to the electrochemical machining fluid within approximately ten hours to make electrodeposition and recovery.

7. The electrochemical machining method according to claim 1, wherein a time is set in which the electrode is used as a positive electrode to chemically dissolve the tungsten oxide (WO3) produced by the anodization, with which the electrode is switched between positive and negative repeatedly in an alternating manner,
graphite is used for the electrode,
a saline solution (aqueous solution of NaCl) is used as the electrochemical machining fluid, and
cobalt chloride (CoCl2), nickel chloride (NiCl2), ferrous chloride (FeCl2) or ferric chloride (FeCl3) is added to the electrochemical machining fluid.

8. The electrochemical machining method according to claim 7, wherein the amount of cobalt chloride (CoCl2), nickel chloride (NiCl2), ferrous chloride (FeCl2) or ferric chloride (FeCl3) to be added to the electrochemical machining fluid is in a range of 0.1wt % or more, and a temperature of the fluid is raised to 30° C. or higher for stronger reaction.

9. The electrochemical machining method according to claim 7, wherein calcium salt is added to the electrochemical machining fluid in a second tank provided separately from a machining tank in which the electrochemical machining is performed.

10. An electrochemical machining method, in which electrochemical machining is performed by applying a voltage to pass a current between an electrode and a hard metal that is a workpiece with the electrode used as a negative electrode such that tungsten carbide (WC) that is a component of the hard metal workpiece is anodized to form a tungsten oxide (WO3) and, at the same time, cobalt (Co) is electrolytically eluted, and by chemically dissolving the tungsten oxide (WO3) generated by the anodization, the method comprising:
setting a time in which the electrode is used as a positive electrode to chemically dissolve the tungsten oxide (WO3) produced by the anodization, with which the electrode is switched between positive and negative repeatedly in an alternating manner;
using graphite for the electrode;
using nitrate of soda (Na(NO3)) or potassium nitrate (K(NO3)) for the electrochemical machining fluid;
adding iron nitrate (II)(Fe(NO3)2).6H20), iron nitrate (III)(Fe(NO3)3.9H(H2O), nitrates of cobalt (2Co(NO2)3.6KNO2.3H2O), or nickel nitrate (Ni(NO3)2.6H2O) to the electrochemical machining fluid;
adding in advance a calcium salt to the electrochemical machining fluid to cause tungstate soda (Na2WO4) produced by the electrochemical machining, and the calcium salt to undergo a reaction whereby calcium tungstate (CaWO4) is produced; and
separating and recovering a calcium compound by using a difference in specific gravity.

11. The electrochemical machining method according to claim 10, wherein the amount of iron nitrate (II)(Fe(NO3)2).6H20), iron nitrate (III)(Fe(NO3)3.9H(H2O), nitrates of cobalt (2Co(NO2)3.6KNO2.3H2O), or nickel nitrate (Ni(NO3)2.6H2O) to be added to the electrochemical machining fluid is in a range of 0.1 wt % or more, and a temperature of the fluid is raised to 30° C. or higher for stronger reaction.

12. The electrochemical machining method according to claim 1, wherein a time is set in which the electrode is used as a positive electrode to chemically dissolve the tungsten oxide (WO3) produced by the anodization, with which the electrode is switched between positive and negative repeatedly in an alternating manner,
graphite is used for the electrode, and
NaOH is added to the electrochemical machining fluid containing mainly NaCl or NaNO3 to cause Cl gas or NO3 gas, which is generated, to react with NaOH and be absorbed in the machining fluid.

13. The electrochemical machining method according to claim 12, wherein a hydrogen ion concentration in the machining fluid is measured to control the addition of NaOH such that the machining fluid is made to be alkaline.

14. An electrochemical machining method, in which electrochemical machining is performed by applying a voltage to pass a current between an electrode and a hard metal that is a workpiece with the electrode used as a negative electrode such that tungsten carbide (WC) that is a component of the hard metal workpiece is anodized to form a tungsten oxide (WO3) and, at the same time, cobalt (Co) is electrolytically eluted, and by chemically dissolving the tungsten oxide (WO3) generated by the anodization, the method comprising:
using an electrochemical machining fluid containing sodium carbonate (Na2CO3) or sodium hydrogen carbonate (NaHCO3) to supply the electrochemical machining fluid with sodium hydroxide (NaOH) needed to chemically dissolve the tungsten oxide (WO3) produced by the anodization; heating the machining fluid to a temperature of 63° C. or higher to thereby release CO2 and produce NaOH when the electrochemical machining is executed; and making CO2 to pass through the electrochemical machining fluid to restore sodium carbonate (Na2CO3) or sodium hydrogen carbonate (NaHCO3) when the electrochemical machining is not executed.

15. An electrochemical machining fluid for use in electrochemical machining of a hard metal, the fluid comprising a saline solution (aqueous solution of NaCl) or an aqueous solution of nitrate of soda (aqueous solution of NaNo3) to which calcium salt is added.

16. An electrochemical machining apparatus comprising: a power source to apply an AC voltage between an electrode and a workpiece that is a hard metal; and
a machining tank that stores therein an electrochemical machining fluid containing a saline solution (aqueous solution of NaCl) or an aqueous solution of nitrate of soda (aqueous solution of NaNo3) to which a calcium salt is added.

17. The electrochemical machining apparatus according to claim 16, comprising:
a tank into which the machining fluid flows from the machining tank; and
an electrodeposition unit that recovers at least one of Co, Ti and Ta from the machining fluid in the tank by electrodeposition.

18. The electrochemical machining apparatus according to claim 17, wherein the electrodeposition unit comprises:
a first electrode having a cylindrical shape;
a second electrode disposed in such a manner that the second electrode surrounds the first electrode with a predetermined gap between the first electrode and the second electrode, the second electrode having a hollow tubular shape and having, in a partial area of the second electrode, a cutout in a direction of a central axis of the tubular shape;
a power source to supply a voltage with the first electrode being used as a negative electrode and the second electrode being used as a positive electrode;
a driver to rotate the first electrode about a central axis of the cylindrical shape; and
a planar scraper disposed in the cutout of the second electrode and in butt contact with a side of the first electrode along the central axis of the cylindrical shape.

19. The electrochemical machining apparatus according to claim 16, comprising:
a cover to cover over a surface of the machining fluid in the machining tank;
a tank to store therein an aqueous solution of caustic soda;
a pipe to discharge gas from a space covered by the cover into the aqueous solution of caustic soda in the tank; and
a meter to measure a hydrogen ion concentration of the aqueous solution of caustic soda in the tank.
